(19) United States
(12) Patent Application Publication
(10) Pub. No.: US 2015/0147206 A1
(43) Pub. Date: May 28, 2015

(54) VALVE FOR METERING MEDIA IN THE MICRO-QUANTITY RANGE

(71) Applicant: Marco Systemanalyse und Entwicklung GmbH, Dachau (DE)

(72) Inventor: Martin Reuter, Dachau (DE)

(21) Appl. No.: 14/550,190

(22) Filed: Nov. 21, 2014

(30) Foreign Application Priority Data
Nov. 28, 2013 (DE) 102013224453.3

(51) Int. Cl. F04B 49/22; F16K 99/00; F04B 43/00; F04B 43/09; F04B 19/00

(52) U.S. Cl. CPC F04B 49/22; F04B 43/095; F04B 19/006; F04B 43/0063; F16K 99/0011; F16K 2099/0094
USPC 417/412; 251/326; 417/472; 417/474

(57) ABSTRACT

This invention relates to a valve for metering filled and/or pasty media. In accordance with an embodiment, the valve comprises a valve element having a metering opening and a valve gate movable in translation and having a flow opening. The valve gate is configured for carrying out an oscillating double-stroke movement in the course of which the flow opening of the valve gate is temporarily aligned with the metering opening of the valve element. The flow opening of the valve gate is aligned with the metering opening of the valve element in the course of the double-stroke movement of the valve gate a first time during the forward stroke and a second time during the backward stroke.

The present invention relates to valves for metering media in the small-quantity and micro-quantity range and in particular to a valve for metering filled and/or pasty media in accordance with the preamble of claim 1 such as has become known from DE 10 2007 020 361 A1.

Although it is possible to meter small media quantities with the valve described in DE 10 2007 020 361 A1, there is a need for a very precise metering of pasty and/or filled media in the micro-quantity range during the production process of the products due to the ever further increasing miniaturizing of industrial products.

To meet this demand, two perforated valve plates are pushed to and fro in an oscillating manner between two end positions in the valve described in DE 10 2007 020 361 A1, wherein the perforations of the two perforated valve plates are only aligned with one another in one of these two end positions so that the medium to be metered can pass through them. Although oscillation frequencies of up to approximately 1 kHz can be achieved on the basis of the valve design described in DE 10 2007 020 361 A1, the length of time for which the valve is open is, however, comparatively long, which is due to the fact that the perforations of the two perforated valve plates are aligned with one another in the region of one of the two end positions of the oscillating to and fro movement at a point in time at which the relative speed of the two perforated valve plates tends toward zero. This has the consequence that the valve is open for approximately one third of the total period length.

Since this open time can also hardly be further reduced with the valve design described in DE 10 2007 020 361 A1, a possible approach for a further reduction of the metering quantity comprises reducing the pressure on the medium and thus the flow speed thereof so that a smaller quantity of the medium to be metered can pass through the open valve during the open time of the valve. However, the supply pressure can also not be reduced by any desired amount since otherwise the energy is no longer sufficient to break through the surface tension of the medium to be metered so that fine droplets can be released from the medium to be metered as is desired with the contactless metering known as “jetting”.

Since the valve diameter can in particular not be reduced as desired to reduce the metering quantity when metering filled media due to the filling materials (e.g. glass beads having a diameter of approximately 50 μm) contained therein, there is still a need for a valve with which in particular filled and/or pasty media in the micro-quantity range can be metered very precisely.

It is therefore the underlying object of the invention to meet this demand.

This object is satisfied in accordance with a first aspect by a valve having the features of claim 1.

Like the valve described in DE 10 2007 020 361 A1, the valve in accordance with the invention also has a valve element having a metering opening and a valve gate movable in translation and having a flow opening so that reference is explicitly made at this point with respect to further details of these two elements and with respect to the means for bringing about the movement in translation of the valve gate to the corresponding statements in DE 10 2007 020 361 A1 which are therefore herewith included herein by reference to DE 10 2007 020 361 A1.

Like the already known valve, the valve gate of the valve in accordance with the invention is also configured for carrying out an oscillating double-stroke movement in the course of which the flow opening of the valve gate is temporarily aligned with the metering opening of the valve element. Provision is, however, now made in accordance with the invention that the flow opening of the valve gate is aligned with the metering opening of the valve element at two times in the course of each double-stroke movement of the valve gate, namely a first time during the forward stroke and a second time during the backward stroke.

Unlike the valve known from DE 10 2007 020 361 A1, the perforations of the perforated valve plates are therefore not aligned at a point in time at which the valve gate reaches a dead center of the double-stroke movement in the course of its double-stroke movement; provision is rather made in accordance with the invention that the valve gate moves beyond the valve element in the course of its double-stroke movement such that the flow opening of the valve gate is aligned with the metering opening of the valve element between the two dead centers. Since the valve gate reaches its maximum speed at the middle of its path between the two dead centers, the flow opening of the valve gate is therefore only aligned with the metering opening of the valve element for a very small length of time, whereby it becomes possible in the desired manner further to reduce the media quantity to be metered.

To ensure that the flow opening of the valve gate can move at both sides beyond the valve element and in particular beyond its metering opening in the course of its double-stroke movement, an increase of the stroke of the double-stroke movement from approximately 700 μm to approximately 1000 μm may be necessary under certain circumstances; however, this is only slightly noticeable in the achievable oscillation frequency. In contrast, however, due to the fact that the two openings are aligned with one another when the valve gate has reached its maximum speed between the two dead centers, the valve opening duration can be reduced from approximately a third of the period length to approximately a tenth of the period length so that the benefits which can be achieved hereby with respect to the reduction of the metering quantity are highly predominant in comparison with any reduction of the achievable oscillation frequency.

Advantageous embodiments of the valve will now be looked at in the following, with further embodiments also resulting from the description of the Figures, from the drawings and from the dependent claims.

Provision is thus made in accordance with an embodiment that the metering opening of the valve element is closed by the valve gate during that portion of the double-stroke movement which lies between the two open positions during which the flow opening of the valve gate is respectively aligned with the metering opening of the valve element in the course of the double-stroke movement of the valve gate. The flow opening of the valve gate is therefore moved so far beyond the metering opening of the valve element that the metering opening of the valve element is completely closed. In this respect, the metering opening of the valve element is in particular closed by the valve gate when the valve gate is located at one of its two dead centers in the course of its double-stroke movement so that no medium to be metered can pass through the valve during the comparatively long dwell time of the valve gate at the two dead centers.

Provision is made in accordance with a preferred embodiment that the flow opening of the valve gate is at least aligned with the metering opening of the valve element during each double-stroke movement of the valve gate in each case when the speed of the valve gate reaches a maximum in the course of its double-stroke movement between the two dead centers of the double-stroke movement. Although a substantial reduction in the media quantity to be metered can hereby be achieved in the already previously explained manner in that the length of time for which the perforations of the perforated valve plates are aligned with one another is minimized, it is, however, likewise possible that the metering opening of the valve element is or can be arranged somewhat eccentrically with respect to the two dead centers of the double-stroke movement of the valve gate since hereby the open time of the valve and thus the metering quantity can be changed in a simple manner.

As can be seen from the above statements, it is possible to reduce the metering quantity with the valve in accordance with the invention without the supply pressure having to be reduced for this purpose in that the valve gate is moved beyond the metering opening of the valve element at both sides in the course of its double-stroke movement. Sufficient energy is thus provided by the supply pressure to overcome the surface tension of the medium to be metered so that individual droplets can be released from the medium.

To be able to reduce the metering quantity even further, there would generally also be the possibility in the already previously explained manner to reduce the supply pressure and thus the flow speed of the medium. If, however, the supply pressure becomes too small, sufficient energy may no longer be present under certain circumstances to overcome the surface tension of the medium to be metered so that individual droplets can be released from the medium.

Accordingly, the underlying object of the invention in accordance with a second aspect is furthermore satisfied by a valve which has the features of claim 14 and is preferably in fluid communication with the metering opening of a valve element downstream of the valve element of the valve in accordance with claim 1. The valve in accordance with claim 14 is admittedly preferably used in conjunction with the valve in accordance with claim 1 in odder thus to be able to further reduce the achievable metering quantity with the help of the valve in accordance with claim 1. The valve in accordance with claim 14 can, however, also be combined in conjunction with a conventional metering valve such as the valve described in DE 10 2007 020 361 A1 in order thus to be able to further reduce the metering quantity only by the reduction of the supply pressure without this being at the expense of the droplet release.

Provision is made in the valve in accordance with claim 14 that it has a resilient compression or contraction body having a compression cavity formed therein which is in fluid communication with metering opening of a valve element downstream of said valve element, such as the valve element of the valve of claim 1. The volume of the compression cavity can in this respect be reduced due to the resilience of the compression body such that metering medium dispensed into the compression cavity is pressed or accelerated through a nozzle, the nozzle being in downstream fluid communication with the compression cavity. The metering medium hereby has sufficient energy to overcome the surface tension to meter out a droplet and to apply it to a substrate.

In the following, preferred embodiments of the valve in accordance with the second aspect of the invention (claim 14) will be looked at, with further embodiments also being able to result from the description of the Figures, from the drawings and from the claims dependent on claim 14.

Provision is thus made in accordance with an embodiment that the volume of the compression cavity which extends between the metering opening of the valve element and the nozzle in downstream fluid communication with the compression cavity can be compressed between the metering opening and the nozzle for a volume reduction in the flow direction and/or perpendicular to the flow direction. For example, the compression cavity can be formed by a resilient body, for example a hose, which can be compressed in the radial direction in order thus to bring about the desired volume reduction. In accordance with another embodiment, the compression cavity can, for example, be formed by an e.g. substantially spherical resilient bubble which can be compressed in the axial direction in the flow direction between the metering opening and the nozzle in order thus to be able to bring about the desired volume reduction.

In accordance with a further embodiment, the valve has at least one actuator, in particular a piezo-actuator which acts at least indirectly on the compression cavity or on the compression body and with whose aid the desired volume reduction of the compression cavity can be brought about. For this purpose, the at least one actuator can act at least indirectly on the compression cavity in the flow direction and/or perpendicular to the flow direction between the metering opening and the nozzle.

If the compression cavity is, for example, formed in the already named manner by a resilient hose, one or more actuators can thus act radially on the hose for a volume reduction in order thus to be able to press the metering medium in the compression cavity out thereof through the nozzle. If the compression cavity is, in contrast, formed by a resilient bubble, one or more actuators can be arranged axially in the flow direction in order thus to be able to act on the bubble such that it is compressed in or against the flow direction and thus in the axial direction.

So that the metering medium can be pressed through the nozzle in the desired manner as a result of the volume reduction of the compression cavity and is not, for instance, pressed back into a metering valve located upstream, provision is made in accordance with a further embodiment that the at least one actuator is only caused to reduce the volume of the compression cavity by correspondingly configured control electronics when the metering opening of the valve element is closed by the valve gate. The metering medium can thus not escape from the compression cavity through the closed valve upstream of the compression cavity so that it is only pressed outwardly and accelerated through the nozzle in the desired manner as a result of the reduction of the volume of the compression cavity.

Although the compression body has a certain shape restoring capability due to its resilience by which the compression cavity can be moved back into its starting position after its volume reduction, provision is made in accordance with a further embodiment that an additional restoring element is provided which counteracts a volume reduction of the compression cavity. It can hereby be achieved that the compression cavity again returns very quickly into its starting shape after a volume reduction has taken place. The change in shape of the compression cavity thus does not trail behind the excitation frequency of the piezo-actuators, whereby very high clock frequencies can be achieved.

The invention will be described in the following with reference to two exemplary embodiments while referring to the enclosed drawings, wherein:

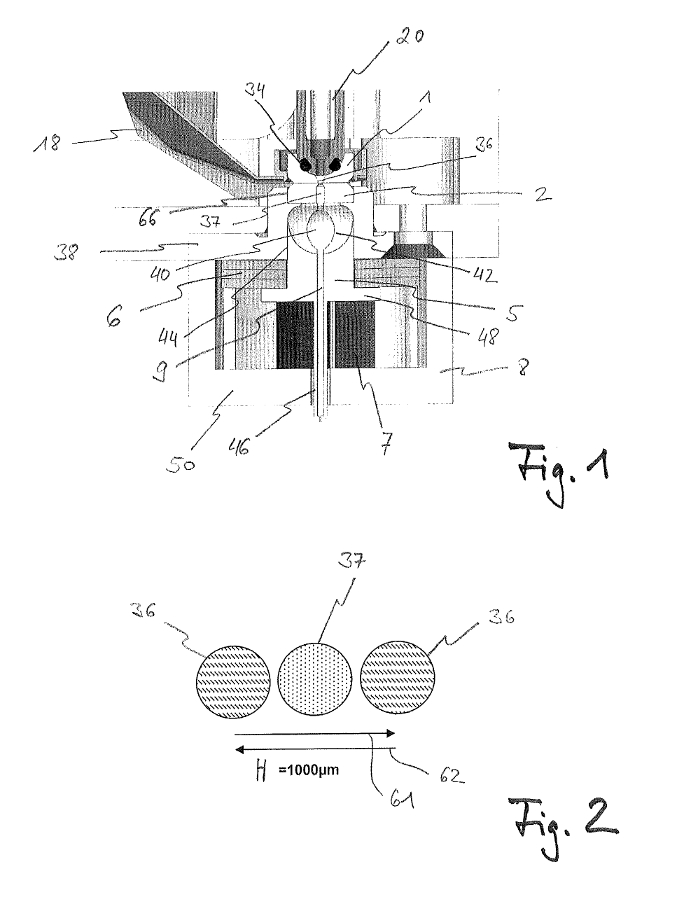

FIG. 1 shows a sectional representation of an embodiment of a valve;

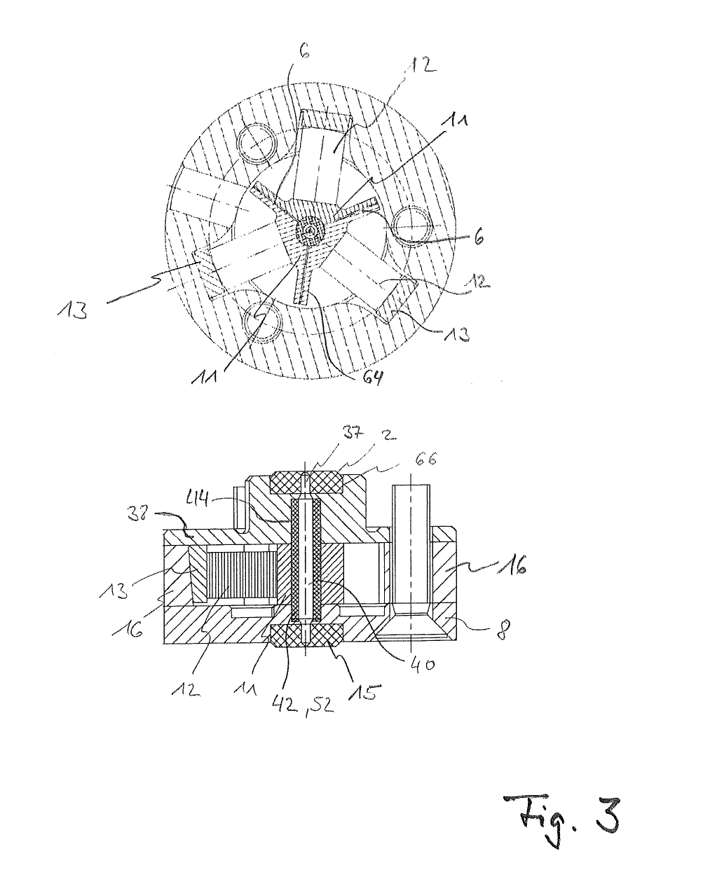

FIG. 2 illustrates the double-stroke movement of the valve gate; and

FIG. 3 shows a second embodiment of a valve in accordance with the invention in a horizontal and a vertical sectional representation.

The valve shown in FIG. 1 corresponds in its basic design above and including the valve element 2 to the valve described in DE 10 2007 020 361 A1 so that reference is made with respect to the basic design of these components to DE 10 2007 020 361 A1 which is herewith included herein by reference.

As can be seen from FIG. 1, the media passage which is not shown here and via which the medium to be metered is supplied to the valve continues in the form of a supply line 20 which can be either a pipe or a hose. In continuation of the downstream end of the supply line 20, a valve gate 1 is coupled to the supply line 20 and is sealed with respect to it by an O ring 34. In order not to impede the flow of the medium through the supply line 20, the valve gate 1 has a flow opening 36 through which the medium can be dispensed to the metering opening 37 of the valve element 2 which is fitted into a receiver 66 of an adjustment plate 38 which is in turn fastened at the lower side to a housing 30 in which the valve is accommodated. The metering opening 37 of the valve element 2 in this respect continues downstream in a compression cavity 40 which is substantially oval in cross-section and which is formed in the interior of a resilient compression body 42 which is arranged within a reception cavity 44 formed in the adjustment plate 36.

Downstream of the compression body 42, the compression cavity 40 is in fluid communication with a nozzle passage 9 which is formed in an annular piston 5 partly received by the reception cavity 44 and which continues in a nozzle pin 46 extending from it. At its lower free end, the annular piston 5 is surrounded by a flange 48, with a restoring spring 6 being fitted into the spacing between the flange 48 and the lower side of the adjustment plate 38 by which restoring spring the annular piston 5 tends to be caused to relieve the compression body 42. Furthermore, an actuator in the form of a piezo-stack 7 is arranged between the free end of the annular piston 5 and the base 50 of a housing body 8 attached to the lower side of the adjustment plate 38 and the volume of the compression cavity 40 formed in the compression body 42 can be reduced by the actuation of said piezo-stack via the annular piston 5.

The medium supplied to the valve via the media passage not shown here thus flows through the supply line 20 to the valve gate 1 or through its flow opening 36 in order to be supplied to the nozzle pin 46 via the compression cavity 40 through the metering opening 37 of the valve element 2 so that it can be dispensed in a meter manner by said nozzle pin.

To prevent a continuous flow on the just described flow path of the medium to be metered for purposes of metering, the valve gate 1 is in friction locking contact with the valve element 2 and is in particular displaceable in translation transversely to the metering opening 37. A flow of the medium and thus the dispensing of the medium to be metered from the nozzle pin 46 is thus only possible when the flow opening 36 is aligned with the metering opening of the valve element 2, that is the valve is open. If, however, the valve gate 1 is moved to the side and if the flow opening 36 is not aligned with the metering opening 37 of the valve element 2, that is the valve is closed, a flow of the medium to be metered is suppressed.

To be able to dispense the medium to be metered in the small quantity and micro-quantity range via the metering needle 46, it is accordingly necessary to cause the valve gate 1 to make a high frequency translatory stroke movement transversely to the metering opening 37 so that the metering opening 37 is always only opened briefly when the flow opening 36 of the valve gate 1 is aligned with the metering opening 37.

To cause the valve gate 1 to make this high frequency translatory stroke movement, the valve comprises an actuation actuator which is not shown here and which is designated by the reference numeral 16 in DE 10 2007 020 361 A1 which is herewith explicitly referenced. As is described in detail in DE 10 2007 020 361 A1, the oscillating tilt movement of the named actuating actuator is converted via the lever arm 18 shown in approximation here in FIG. 1 into a translatory stroke movement of the valve gate 1 to be able to alternatingly open and close the metering opening 37 in the desired manner.

Provision is now made in accordance with the invention that the flow opening 36 of the valve gate 1 is aligned with the metering opening 37 of the valve element 2 in the course of each double-stroke movement of the valve gate 1 a first time during the forward stroke 61 and a second time during the backward stroke 62, as is made clear in FIG. 2, from which it can be seen that the flow opening 36 completely moves over the metering opening 37 in both directions in the course of the double-stroke movement 61, 62 so that the metering opening 37 of the valve element 2 is closed by the valve gate 1 during that portion of the double-stroke movement 61, 62 which is disposed between the two opening positions of the valve during which the flow opening 37 of the valve gate 1 is respectively aligned with the metering opening 36 of the valve element 2 in the course of the double-stroke movement 61, 62 of the valve gate 1. The metering opening 37 of the valve element 2 is therefore closed by the valve gate 1 when the valve gate 1 is located at one of its two dead centers in the course of its double-stroke movement 62, 62.

The flow opening 36 of the valve gate 1 is thus aligned with the metering opening 37 of the valve element 2 during the double-stroke movement 61, 62 of the valve gate 1 in each case when the speed of the valve gate 1 reaches a maximum in the course of its double-stroke movement 61, 62 between the two dead centers of the double-stroke movement 62, 62 so that an only very small metering quantity can be dispensed from the valve in the desired manner during this reduced opening period of the valve. If in this respect, the supply pressure present in the medium to be metered is sufficiently high, it is generally possible to dispense with the provision of a further valve arranged downstream of the valve element 2 since it is basically only required when the supply pressure is not high enough to be able to overcome the surface tension of the medium for releasing individual droplets.

If, however the supply pressure in the medium to be metered is so small that the surface tension of the medium to be metered cannot be overcome for the release of individual droplets, it becomes possible with the aid of a volume reduction of the compression cavity 40 of the compression body 42 to accelerate the medium dispensed into the compression cavity 40 from the above-described valve through the nozzle pin 46 in the manner of a pulse, which desirably has the result that individual droplets of the medium to be dispensed can be metered very precisely.

The volume reduction of the compression cavity 40 formed in the compression body 42 in this respect takes place via an actuation of the piezo-actuator 7 to make high frequency oscillations, wherein the oscillation frequency of the piezo-actuator 7 is preferably coordinated with the oscillation frequency of the valve gate 1. The oscillation movement of the piezo-actuator 7 is in this respect transferred via the annular piston 5 to the compression body 42, whereby the latter is compressed in the longitudinal direction or in the axial direction. This has the consequence that the metering medium dispensed into the compression cavity 40 is pressurized and is thus accelerated through the nozzle pin 46 in the desired manner. So that the compression body 42 can return to its starting position again after a compression has taken place by the piezo-actuator 7, the restoring spring 6 fitted into the spacing between the adjustment plate 38 and the flange 48 of the annular piston 5 counteracts the volume reduction of the compression cavity 40.

So that the medium located in the compression cavity 40 is not pressed back into the metering opening 37 of the valve element 2 as a result of the volume reduction of the compression cavity 40, control electronics (not shown) are furthermore provided which are configured to cause the piezo-actuator 7 to reduce the volume of the compression cavity 40 when the metering opening 37 of the valve element 2 is closed by the valve gate 1. The actuation actuator acting on the valve gate 1 via the lever arm 18 can be controlled independently of the piezo-actuator 7 by the control electronics so that both actuators can be directly actuated with different voltage developments at different points in time. In this respect, the metering opening 37 of the valve element 2 is preferably opened first in order to be able to dispense a small volume of the medium to be dispensed through it into the compression cavity 40 so that once the metering opening 37 has been closed again, the medium dispensed into the compression cavity 40 can be pressed outwardly through the nozzle pin 46 in a pulsed manner by actuation of the piezo-actuator 7 and can thus be dispensed droplet-wise.

In the embodiment previously described with reference to FIG. 1, the compression cavity 40 is formed by a bubble-like resilient compression body 42 which is compressed in the axial direction for bringing about the volume reduction of the compression cavity 40. In contrast, in the illustrations of FIG. 3, an embodiment of a valve is shown in which the compression cavity 40 is formed by a resilient hose 52 which connects the metering opening 37 of the valve element 2 fluid-wise to a metering nozzle 15. The hose in this respect extends into a reception cavity 44 in the adjustment plate 48 and is surrounded by three radially extending piezo-actuators 12 which each act in a radial direction on the hose 52 via a piston segment 11. The piezo-actuators 12 are in this respect arranged in a cup-like housing body 8 attached to the adjustment plate 38 and are tensioned toward the container wall 16 with the aid of wedges 13.

If a quantity of a medium to be metered has been dispensed into the compression cavity 40 of the hose 52 with the aid of any desired metering valve, for example the valve described in DE 10 2007 020 361 A1, this metered quantity can be dispensed droplet-wise in a metered manner with the aid of the valve arrangement shown in FIG. 3 in that the piezo-actuators 12 are caused to make oscillating movements synchronously while using the previously mentioned control electronics. The compression cavity 40 of the hose 52 is hereby compressed in the radial direction so that the metering medium located in the compression cavity 40 can be dispensed in the form of individual droplets in a metered manner through the nozzle 15. However, this requires that the metering medium cannot be pressed back into the metering opening 37 of the valve element 2, which can be prevented while using the control electronics in accordance with the above statements in that the piezo-actuators 12 are only caused to reduce the volume of the compression cavity 40 exactly when the metering opening 37 of the valve element 2 is closed by the valve gate 1.

So that the hose 52 can adopt its starting shape quickly again after a compression by the piezo-elements has taken place, restoring elements in the form of spring arms 6 are also provided in the embodiment shown in FIG. 3 which counteract the volume reduction of the compression cavity 40. In this respect, two respective spring arms 6 project from each of the piston segments 11 and are formed in one piece with the respective piston segment 11, with the spring arms 6 only contacting adjacent piston segments 11 at the outermost end. In contrast, the spring arms 6 of adjacent piston segments 11 lie radially inwardly from this contact point at the outermost end of the spring arms 6 spaced apart by a gap, which gives the piston segments 11 a certain movement freedom in the radial direction.

### REFERENCE NUMERAL LIST

1 valve gate
2 valve element
5 annular piston
6 restoring spring or spring arm
7, 12 piezo-actuator
8 housing body
9 nozzle passage
11 piston segment
13 wedge
15 nozzle
16 container wall
18 lever arm
20 supply line
34 O ring seal
36 flow opening in 1
37 nozzle opening
38 adjustment plate
40 compression cavity
42 compression body
44 reception cavity in 38
46 nozzle pin
48 flange at 5
50 base of 8
52 hose
61 forward stroke
62 backward stroke
64 end face at 11
66 receiver in 38

1. A valve comprising:
a valve element having a metering opening; and
a valve gate movable in translation and having a flow opening, wherein the valve gate is configured for carrying out an oscillating double-stroke movement in the course of which the flow opening of the valve gate is temporarily aligned with the metering opening of the valve element;
wherein the double-stroke movement comprises a forward stroke and a backward stroke; and
wherein the flow opening of the valve gate is aligned with the metering opening of the valve element in the course of each double-stroke movement of the valve gate a first time during the forward stroke and a second time during the backward stroke.

2. The valve in accordance with claim 1, wherein the valve is provided for metering filled and/or pasty media.

3. The valve in accordance with claim 1, in which the metering opening of the valve element is closed by the valve gate during that portion of the double-stroke movement which lies between the two opening positions of the valve during which the flow opening of the valve gate is respectively aligned with the metering opening of the valve element in the course of the double-stroke movement of the valve gate.

4. The valve in accordance with claim 1, in which the metering opening of the valve element is closed by the valve gate when the valve gate is located at one of its two dead centers in the course of its double-stroke movement.

5. The valve in accordance with claim 1, in which the flow opening of the valve gate is at least respectively aligned with the metering opening of the valve element during each double-stroke movement of the valve gate when the speed of the valve gate reaches a maximum in the course of its double-stroke movement between the two dead centers of the double-stroke movement.

6. The valve in accordance with claim 1, in which the valve has a resilient compression body having a compression cavity formed therein which is in fluid communication with the metering opening of the valve element downstream of said valve element, wherein the volume of the compression cavity can be reduced due to the resilience of the compression body such that metering medium dispensed into the compression cavity is pressed through a nozzle, with the nozzle being in downstream fluid communication with the compression cavity.

7. The valve in accordance with claim 6, in which the volume of the compression cavity, which extends between the metering opening of the valve element and the nozzle, can be compressed for reducing its volume in or against the flow direction and/or perpendicular to the flow direction between the metering opening and the nozzle, with the nozzle being in downstream fluid communication with the compression cavity.

8. The valve in accordance with claim 6, further comprising at least one actuator which acts at least indirectly on the compression cavity to reduce the volume of the compression cavity.

9. The valve in accordance with claim 8, in which the at least one actuatoracts at least indirectly on the compression body to reduce the volume of the compression cavity in or against the flow direction and/or perpendicular to the flow direction between the metering opening and the nozzle.

10. The valve in accordance with claim 6, in which the compression cavity is formed by a resilient hose on which one or more actuators act to reduce its volume in the radial direction.

11. The valve in accordance with claim 6, in which the compression cavity is formed by a resilient bubble on which one or more actuators act to reduce its volume in or against the flow direction between the metering opening and the nozzle.

12. The valve in accordance with claim 8, further comprising control electronics that are configured in such a way to cause the at least one actuator to reduce the volume of the compression cavity when the metering opening of the valve element is closed by the valve gate.

13. The valve in accordance with claim 6, further comprising at least one restoring element which counteracts a volume reduction of the compression cavity.

14. A valve having a resilient compression body, the compression body having a compression cavity formed therein which is in fluid communication with a metering opening of a valve element downstream of said valve element, wherein the volume of the compression cavity can be reduced due to the resilience of the compression body such that metering medium dispensed into the compression cavity is pressed through a nozzle, with the nozzle being in downstream fluid communication with the compression cavity.

15. The valve in accordance with claim 14, in which the volume of the compression cavity, which extends between the metering opening of the valve element and the nozzle, can be compressed for reducing its volume in or against the flow direction and/or perpendicular to the flow direction between the metering opening and the nozzle, with the nozzle being in downstream fluid communication with the compression cavity.

16. The valve in accordance with claim 14, further comprising at least one actuator which acts at least indirectly on the compression cavity to reduce the volume of the compression cavity.

17. The valve in accordance with claim 16, in which the at least one actuatoracts at least indirectly on the compression body to reduce the volume of the compression cavity in or against the flow direction and/or perpendicular to the flow direction between the metering opening and the nozzle.

18. The valve in accordance with claim 14, in which the compression cavity is formed by a resilient hose on which one or more actuators act to reduce its volume in the radial direction; or
in which the compression cavity is formed by a resilient bubble on which one or more actuators act to reduce its volume in or against the flow direction between the metering opening and the nozzle.

19. The valve in accordance with claim 16, further comprising control electronics that are configured in such a way to cause the at least one actuator to reduce the volume of the compression cavity when the metering opening of the valve element is closed by the valve gate.

20. The valve in accordance with claim 14, further comprising at least one restoring element which counteracts a volume reduction of the compression cavity.
